(19) United States
(12) Patent Application Publication
(10) Pub. No.: US 2005/0232580 A1
(43) Pub. Date: Oct. 20, 2005

(54) Control of device operation within an area

(75) Inventors: Steven Jeffrey Goldberg, Downingtown, PA (US); Richard Dan Herschaft, Whitestone, NY (US); Alain Charles Louis Briancon, Poolesville, MD (US); Debashish Purkayastha, Pottstown, PA (US); John Thommana, Austin, TX (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/077,914

(22) Filed: Mar. 11, 2005

Related U.S. Application Data
(60) Provisional application No. 60/552,403, filed on Mar. 11, 2004.
(60) Provisional application No. 60/631,328, filed on Nov. 29, 2004.

(51) Int. Cl. H04N 5/76

(52) U.S. Cl. 386/46

(57) ABSTRACT

A method and apparatus are disclosed for selectively regulating devices. In a wireless communication system, a regulation zone is defined. Devices within a regulation zone (e.g. an electronic do-not-disturb (EDND) zone) are regulated by generating and transmitting inhibiting signals into or near the regulation zone. The inhibiting signals may be messages instructing devices to disable one or more of their sensing components or actual interference signals that prevent sensing components from functioning properly or watermarks that mark illicit recordings so that such illicit recordings are precluded from being transmitted over the network.

### CROSS REFERENCE TO RELATED APPLICATIONS

This application claims the benefit of U.S. Provisional Application No. 60/552,403, filed on Mar. 11, 2004, and No. 60/631,328, filed on Nov. 29, 2004, which are incorporated by reference as if fully set forth.

### FIELD OF INVENTION

The present invention relates to wireless communication systems. More particularly, the present invention is a method and apparatus for selectively regulating the operation of devices.

### BACKGROUND

Advances in technology have enabled manufacturers to miniaturize sensing components. As a result, these miniature sensing components are being embedded into many devices that previously could not house such components. Examples include wireless telephones being embedded with miniature cameras and personal digital assistants (PDAs) being embedded with miniature sound recorders. One problem with these advancements in miniaturization technology is that the physical presence of these sensing components is difficult to detect. Even if certain devices are themselves noticeable, their miniaturized sensing components are not. As a result, devices embedded with these miniaturized sensing components are being used to locally record and disseminate unauthorized images and sounds (media) without the knowledge or consent of the media owners. Wireless telephones embedded with miniature cameras, for example, are used to record and transmit unauthorized images and sounds.

Current methods of regulating recording devices include posting restrictions in protected areas. This method has proven ineffective as illicit users tend to ignore such postings. Manual inspections are also used to regulate recording devices. Manual inspections, however, are impractical and cumbersome, particularly in large or crowded areas.

Accordingly, it is desirable to have a method and apparatus for effectively regulating the recording and dissemination of images and sounds in a defined regulation area.

### SUMMARY

The present invention relates to a method and apparatus for selectively regulating devices. In a wireless communication system, a regulation zone is defined. Devices within the regulation zone (e.g. an electronic do-not-disturb (EDND) zone) are regulated by generating and transmitting inhibiting signals into or near the regulation zone. The inhibiting signals may be messages instructing devices to disable one or more of their sensing components or actual interference signals that prevent sensing components from functioning properly or watermarks that mark illicit recordings so that such illicit recordings are precluded from being transmitted over the network.

### BRIEF DESCRIPTION OF THE DRAWINGS

FIG. 1 is a wireless communication system for generating and broadcasting electronic do-not-disturb (EDND) zones;

FIG. 2 is a local EDND zone created and broadcast from a wireless transmit/receive unit (WTRU) in a wireless communication system

FIG. 3 is a method for regulating recording components embedded in a WTRU using EDND zones; and

FIG. 4 is a signaling diagram of an exemplary process for creating, updating, and canceling of EDND zones.

### DETAILED DESCRIPTION OF THE PREFERRED EMBODIMENTS

Hereafter, a recording device is any type of device having any type of sensing capability (i.e., sensing component(s)), including but not limited to an image sensing device, an audio sensing device, etc. A wireless transmit/receive unit (WTRU) includes but is not limited to a user equipment, mobile station, fixed or mobile subscriber unit, pager, desktop computer, laptop computer, personal digital assistant (PDA), or any other type of device capable of operating in a wireless environment. When referred to hereafter, a base station includes but is not limited to a Node-B, site controller, access point or any other type of interfacing device in a wireless environment.

In implementing the present invention, it should be understood that the various embodiments discussed below are not limited to any particular combination of sensor and another type of functional device. Thus, recording devices required to implement the present invention may be stand alone or be embedded in a functional device in any combination thereof. For example, a recording device may be a device capable of functionally making a recording only (i.e., a stand alone recording device), or the recording device may be embedded in a WTRU, which of course has additional functionality depending on the type of WTRU. Where recording devices are embedded in WTRUs, the resulting device may be referred to as either a recording device or a WTRU.

For purposes of describing the various embodiments of the present invention, sensing components are those features embedded in recording devices that assist the devices in the recording of various media. Light sensing components, for example, are embedded in cameras to assist in the recording of still images, motion pictures, and/or in the relaying of sensed images via wired or wireless means. Similarly, microphones are sound sensing components embedded in various types of recording devices to assist in the recording of local sounds or in the relaying of sensed sound. These sensing components often work in combination to assist in the recording of audio/visual media simultaneously. Video cameras, for example, use multiple sensing components, including light sensors and microphones, in order to record moving images and sounds together. Other examples of sensing components include camera optics, light detecting diodes, speakers, piezo-electric, and the like.

Generally, inhibiting signals may be any type of signals for preventing: (a) the unauthorized use of devices having sensing components; or (b) the illicit recording of data using such devices. Inhibiting signals may be in the form of messages (broadcast, multicast, or otherwise transmitted as desired) instructing recording devices within an electronic do-not-disturb (EDND) zone to disable one or more sensing functions or informing recording devices outside of the EDND zone of the existence of the EDND zone. Inhibiting signals may include actual interference signals that prevent one or more sensing functions to function properly. Inhibiting signals may also be watermarks broadcast into an EDND zone to identify illicit recordings or recorders and prevent their ability to operate in a network. The foregoing are purely examples and any type of mechanisms, signals, or functionality directed toward preventing the unauthorized use of recording devices may be considered inhibiting signals.

In a first embodiment, inhibiting signals include instructions for regulating the operation of sensing components of recording devices embedded in cooperating WTRUs. These sensing components, while they may exist expressly for the purpose of this invention, also include those primarily in the recording device for its normal operative functions. Imaging, acoustical, distance sensing, and energy level detection, for example, are particular functional sensing component serving a primary purpose of the recording device, while also potentially serving a secondary purpose of this application. These inhibiting signals carry enabling and/or disabling information that are recognized by at least one, but preferably by a combination of embedded sensing components. Upon detecting these inhibiting signals, the sensing components cause one or more recording functions to shut down, or if already disabled to remain shut down. Alternately, the inhibiting signals may universally or selectively indicate specific functions that are allowed to operate. In general, total shut down, enablement, or selective combinations can be signaled. While the shut down may affect the primary purpose of a sensing component, its utilization as a detector of inhibiting signals will normally remain active, subject to a modifying control mechanism explained elsewhere in this application.

In addition to carrying disabling and/or enabling information, the inhibiting signals of the present embodiment may be encoded with conditional, limiting, position, and/or device identification information. Encoded conditional information provides user-defined criteria which must be satisfied before the sensing components shut down or enable the specified recording functions. As an example, signals may be broadcast to disable particular sensing functions of only those recording devices that do not have a predetermined override code.

For instances when it is preferable to partially disable (or enable) the use of particular recording functions, inhibiting signals may be encoded with such limiting instructions. These limiting instructions, for example, may be in the form of time limits. To illustrate, suppose for instance that a user wishes to temporarily disable sound recording functions in a concert hall, say for the duration of a concert. The user may broadcast sound inhibiting signals encoded with time limiting data. Upon receiving these command signals, sound-recording components in the concert hall are temporarily shut down. At the expiration of the encoded time limit, the recording functions are automatically reactivated. Alternatively, rather than imposing a pre-determined time limit, the user may broadcast encoded enabling signals to re-activate the recording devices.

Other forms of limiting instructions include forcing the inclusion of a watermark or copyright into a recording, forcing adjustments to quality settings, and the like.

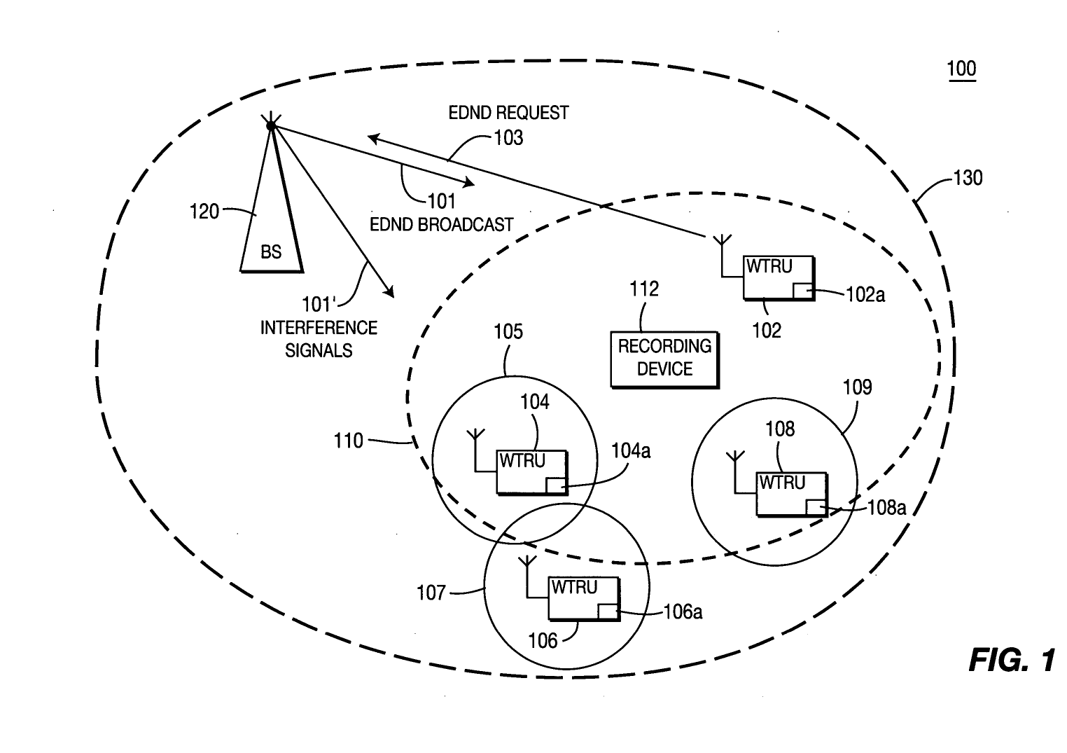

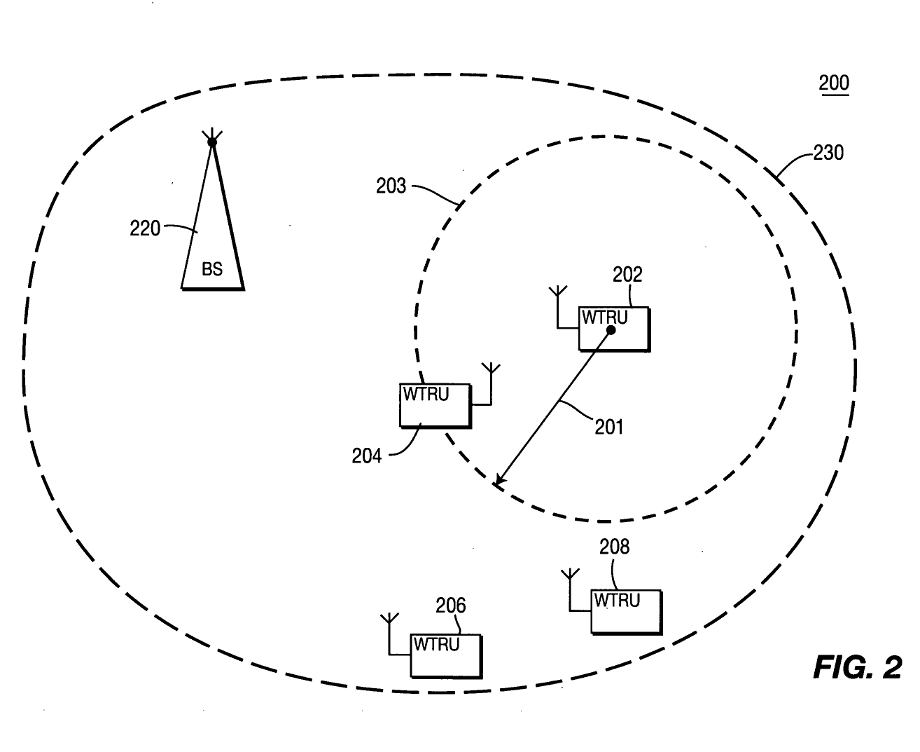

Device positioning information may be included in broadcast inhibiting signals along with enabling and/or disabling inhibiting signals for detection by recording devices embedded in WTRUs having positioning components. The use of positioning information allows users to generate configurable EDND zones either via a base station or directly as explained below in FIGS. 1 and 2, respectively. Upon detecting EDND zone information, cooperating recording devices utilize their own positioning components to determine whether they are within the designated EDND zones. Cooperating devices within the EDND zones disable their respective recording functions accordingly. Once the detecting devices are beyond the EDND zones, they re-activate their previously disabled recording functions.

Inhibiting signals may also be encoded with device identification information. A recording device's serial number, for example, is one form of identification information. Such information is utilized to limit the devices affected by inhibiting signals to those particularly identified in the encoded signals. If, for example, a user prefers to affect a particular recording device or a particular group of devices, he may broadcast inhibiting signals encoded with a unique identifier corresponding to the particular device or group of devices. Only those recording devices whose unique identifiers are encoded in the inhibiting signals process and comply with the signal instructions. In this regard, standard mechanisms may be utilized in the recording device to authenticate the identification information encoded in the inhibiting signals. Recording devices that are unable to authenticate the inhibiting signals simply disregard them as noise.

In another embodiment, inhibiting signals may be interference signals generated as described above and broadcast for detection by sensing components embedded in recording devices. This embodiment is preferably implemented where communications with a recording device is not possible such as, for example, stand alone recording devices and recording devices embedded in rogue WTRUs. Rather than carrying instructions, the inhibiting signals of the present embodiment are broadcast into a regulation or EDND zone and cause sensing components to falsely “perceive” their targeted sensing environments or otherwise disrupt the operation of recording devices. As a result, these sensing components make improper adjustments with respect to the actual sensing conditions, for example, preventing the successful recording of media.

The interfering-type inhibiting signals described above are preferably light signals generated in the electromagnetic spectrum or sound signals generated in certain frequency ranges. These signals are preferably undetectable by humans, detectable by sensing components, and harmless to both. A preferred method for generating such signals utilizes various frequencies ranges, signal durations, and power levels.

Light signals, for example, may be generated in electromagnetic bands which are not visible to humans, yet detectable by optical components used in recording devices. As shown in Table 1 below, the infrared and ultraviolet frequency ranges surround the visible light band. As such, these bands are both undetectable by humans, yet close enough to the visible light band to be detectable by most optical components. Thus, signals generated in the infrared and ultraviolet frequency ranges can be utilized to generate inhibiting signals in accordance with the present embodiment. Alternatively, light signals may be generated within the visual light band at specific frequencies, power levels and/or signal durations so as to be detectable by optical sensing devices, but not by humans. Unlike radio-frequency (RF) signals, signals generated in the electromagnetic spectrum of certain or other bands can be confined to pre-defined areas, such as rooms. This confinement prevents interference-type inhibiting signals that are broadcast directly into confined EDND zones from inadvertently affecting unintended recording devices.

To illustrate, signals generated in the ultraviolet (UV) and infrared (IR) bands of the electromagnetic spectrum are not visible to humans. Similarly, signals generated in the visible light band, if broadcast at certain power levels and/or with certain durations, are equally undetectable by humans. Optical systems utilized in image recording devices (e.g., cameras), however, are highly sensitive to these in and out of band light signals. Thus, the generation and broadcast of such signals in a protected area can cause, for instance, light level sensing components in cameras to falsely indicate high levels of light. Such an indication causes these sensors to become saturated further causing the disabling of the cameras' flash mechanisms. Alternatively, functions such as white balance determination, focusing, or anti-blooming circuitry can be caused to incorrectly adjust for the actual prevailing conditions. As a result, images recorded in the protected area will be distorted and unrecognizable.

TABLE 1
Electromagnetic Spectrum
Spectrum of Electromagnetic Radiation

| | Wavelength | Wavelength | Frequency | |
|---|---|---|---|---|
| Region | (Angstroms) | (cm) | (Hz) | Energy (eV) |
| Radio | >10⁹ | >10 | <3 × 10⁹ | <10⁻⁵ |
| Microwave | 10⁹-10⁶ | 10-0.01 | 3 × 10⁹-3 × 10¹² | 10⁻⁵-0.01 |
| Infrared | 10⁶-7000 | 0.01-7 × 10⁻⁵ | 3 × 10¹²-4.3 × 10¹⁴ | 0.01-2 |
| Visible | 7000-4000 | 7 × 10⁻⁵-4 × 10⁻⁵ | 4.3 × 10¹⁴-7.5 × 10¹⁴ | 2-3 |
| Ultraviolet | 4000-10 | 4 × 10⁻⁵-10⁻⁷ | 7.5 × 10¹⁴-3 × 10¹⁷ | 3-10³ |
| X-Rays | 10-0.1 | 10⁻⁷-10⁻⁹ | 3 × 10¹⁷-3 × 10¹⁹ | 10³-10⁵ |
| Gamma | <0.1 | <10⁻⁹ | >3 × 10¹⁹ | >10⁵ |
| Rays | | | | |

Sound signals may similarly be generated at frequencies above or below those perceivable by humans, or at power levels perceived by humans as noise. Most microphones built into recording devices, for example, can detect sound signals beyond the normal range of human hearing and/or at power levels perceived by humans as noise. Accordingly, it is preferred to generate sound interfering signals at such frequency ranges and/or at such power levels. It should be noted, however, that sound signals may also be generated in the normal human hearing range, so long as the power level and/or duration of such signals are not excessively unpleasant or harmful.

It should be understood that a combination of the above light and sound inhibiting signals may be utilized to cover various recording implementations. In some cases, both types of signals may be necessary to inhibit the various functionality of recording devices.

For instances when a user does not wish to distort all recordings in a protected area, recording devices embedded in cooperating WTRUs may be provided with information regarding the time varying sequences and/or frequencies and intensity of the interference-type inhibiting signals. With this information, authorized recording devices can avoid or filter out these disruptive command signals. This inhibiting signal ‘avoidance’ information is preferably distributed to authorized devices via the manual entry of codes, by encoding and broadcasting such information for reception by authorized devices with a means for decoding the information, via a network or access point using appropriate authentication and access codes such that authorized users may access the information directly or access and decode a broadcast of the encoded information, or by any other suitable means of disseminating such information.

For implementations that transmit interference-type inhibiting signals in bursts, synchronization marks can be transmitted with the bursts such that authorized users may operate recording devices during the gaps between the bursts. Alternatively, watermark information identifying the occurrence, frequency and duration of these usage gaps can be disseminated to authorized users in a manner described above.

A signal emitter for broadcasting inhibiting signals may be deployed to protect particular areas, people and/or objects. As described herein, an emitter may be any type of device capable of emitting any of the various inhibiting signals described above. For example, an emitter may be a signal broadcaster, a base station, a WTRU, a recording device, etc. In a miniaturized form, a signal emitter may be worn as a personal device or fitted into an object conveniently carried by a user, such as in a briefcase, purse, and the like.

Referring now to FIG. 1, a wireless communication network 100 comprising a base station 120 and a plurality of WTRUs 104, 106, 108 is shown. In this network 100, EDND zone information is generated for broadcast (i.e. an EDND broadcast message) by the base station 120 to WTRUs 104, 106, and 108 in the base station's serving cell 130. The EDND broadcast message is based on all of the EDND requests received by the base station 120 from WTRUs operating with the base station's 120 coverage area that wish to establish a EDND zone 110 (e.g., WTRU 102). Therefore, this EDND zone information is comprised of user-defined coverage parameters. These parameters define the EDND zone 110 relative to the WTRU's 102 position coordinates and radius in which recording devices are desired to be disabled (or enabled). Alternatively, the EDND zone information may define a static privacy area which encompasses a static location such as a home, office or the like. Any parameters deemed appropriate by a user may be utilized to define an EDND zone. For instance, a user may specify coverage parameters to create an omni-directional EDND zone with a one-meter radius centered about the user's current position coordinates. Alternatively, a user may prefer to designate his EDND zone as a static, sectorized space with an angle of ten degrees and radius of one-meter centered about the user's home.

Additionally or optionally, a user may designate particular recording device functions that are to be disabled or enabled as part of his EDND zone information. Examples of such functions include image recording (e.g., photographs), sound recording, positioning functions (e.g., global positioning systems (GPS)), and combination of image, sound and/or GPS functions, and the like.

Once WTRU 102 configures its EDND zone information as described above, a position location component 102a is utilized to determine the WTRU's 102 current position coordinates. The WTRU 102 then activates available standardized mechanisms to transmit, wired or wirelessly, the generated position coordinates and the configured EDND zone information to a servicing base station 120 in the form of an EDND request message 103. Since the EDND zone 110 is to be mobile, the WTRU's 102 positioning coordinates are periodically sent to the base station 120. The base station 120, upon receiving the update, modifies the old EDND request with the new information.

Upon receiving the EDND request message 103, the base station 120 generates an EDND broadcast message 101 which includes as an entry, the EDND request message 103. This broadcast message is periodically broadcast from the base station 120 to all WTRUs 104, 106, 108 in its broadcast sector 130. As additional request messages are received at the base station from other WTRUs requesting to establish EDND zones, the additional request messages are added as entries to this broadcast message 101. In this regard, the broadcast message may be described as a listing of EDND request messages.

The base station 120 may optionally segregate received request messages in the broadcast message into a static listing and a dynamic listing for ease of maintenance. The static listing includes messages requesting EDND zones centered about fixed locations, such as homes, offices, and the like. The dynamic listing includes messages requesting EDND zones centered about mobile objects, such as a user.

All active WTRUs 102, 104, 106, 108, in the base station's broadcast sector 130, including the requesting WTRU 102, receive the EDND broadcast message 101. The requesting WTRU 102 monitors these EDND broadcasts to ensure successful reception of its respective request message 103 by base station 120. If unsuccessful, WTRU 102 may optionally resend the request 103. All other non-requesting WTRUs 104, 106, 108 utilize the broadcast EDND information whenever their respective sensing components are being used. As soon as sensing components are activated, for example, broadcast-receiving WTRUs 104, 106, 108 examine all received EDND request messages and determine whether any such message has requested the disablement of their respective sensing component. If no such requests exist, the sensing components are enabled for normal operation. If, however, the sensing components are identified on at least one received request message, the WTRUs 104, 106, 108 determine whether using their respective sensing components interferes with the requested EDND zone 110.

To make such a determination, the receiving WTRUs 104, 106, 108 first identify their respective position coordinates utilizing their respective position location components, 104a, 106a, 108a. Then, based on their current positions, and on the inherent capabilities of the sensing components, the receiving WTRUs each define a “Field-Of-Usage” (FOU) 105, 107, 109, respectively, of their sensing components. The inherent capabilities refer to, for example, the ‘reach’ of the sensing component, such as for example, the ‘reach’ of a zoom lens, the sensitivity of a microphone, the sensitivity of a light sensor, and the like. Accordingly, the defined FOU marks the usage boundary of the sensing component in terms of position coordinates.

It should be noted that sensing components may be configured to inhibit their full achievable ‘reach’ such that their effective FOUs 105, 107, 107 do not enter into the EDND zone 110. These effective FOUs 105, 107, 109 may be continually adjusted as the WTRUs 104, 106, 108 respectively move about the network 100.

Once the sensing components' FOUs 105, 107, 109 are defined, the FOUs are compared to the position coordinates of the requested EDND zone 110. If the sensing components' FOUs 105, 107, 109 fall within the EDND zone 110, the sensing components are disabled. Otherwise, the sensing components are enabled for normal operation. As shown in FIG. 1, each of the WTRUs 104, 106, and 108 have an FOU 105, 107, 109 that falls at least partially within the EDND zone 110. Accordingly, the sensing components of each of these WTRUs 104, 106, 108 will be disabled until they are outside of the EDND zone 110. It should be noted that WTRU 106 is physically located outside of EDND zone 110. However, since the FOU 107 of its sensing components ‘reach’ the EDND zone 110, its components are likewise disabled.

WTRUs 104, 106, 108 continue to periodically determine the distance between their respective components' FOUs 105, 107, 109 and EDND zone 110. Although only one EDND zone 110 is shown, it should be understood that an EDND broadcast may include multiple EDND zone requests. In such a scenario, WTRUs 104, 106, 108 would periodically determine the distance between their respective components' FOUs 105, 107, 109 and all EDND zones.

As the receiving WTRUs 104, 106, 108 approach a requested EDND zone 110, these periodic distance determinations may be made more frequently. Likewise, the further these WTRUs 104, 106, 108 are from a requested zone, the less often such determinations are made. A history of these periodic distance determinations are preferably kept in receiving WTRUs to later interpolate/extrapolate the relative location of requested zones should the receiving WTRU be suddenly cut off from their position location signals or their servicing base station 120.

If the WTRU 102 requesting an EDND zone 110 wishes to cancel its request, it may send an EDND cancel message to the servicing base station 120. Upon receiving this cancel message, the base station 120 removes the appropriate request entry from its broadcast list (i.e. its EDND broadcast message 101). The WTRU 102 verifies receipt of the cancellation message by examining subsequent broadcast messages (not shown). Absence in the broadcast message of the WTRU's 102 request entry signifies successful receipt of the cancel message.

Optionally, to provide protection when a recording device without wireless capabilities is located within the network 100 or when a rogue WTRU (not shown) located within the network 100 ignores, overrides, or does not receive the EDND broadcast message 101, base station 120 may broadcast (or otherwise transmit) other types of inhibiting signals such as the various types of interference signals described above in order to prevent illicit sensing within EDND zone 110. In addition, in the case of a rogue WTRU, the base station 120 may deny any requested services to the rogue WTRU to prevent illicit recordings captured in EDND zone 110 from being transmitted. Also, to prevent a recording device 112 (for example, a digital camera) located in EDND zone 110 from engaging in illicit recording within EDND zone 110, base station 120 may broadcast interference signals (i.e., sensing disabling inhibiting signals) 101′ for detection by any recording device in EDND zone 110, including recording device 112. Upon receiving these interference signals 101′, sensing components embedded in the recording device 112 become disabled or are rendered useless. Additionally, these interference signals 101′ may be broadcast with watermark information such that if a recording device 112 or a rogue WTRU manages to record data within EDND zone 110, it is possible to recognize the recordings as illicit.

In an alternate embodiment, so called local EDND zones are created for broadcasting from a user's WTRU to regulate nearby recording devices. This embodiment is discussed with reference to FIG. 2. In a wireless communication network 200, WTRU 202 configures its desired EDND parameters as described above. Rather than transmitting this information to a servicing base station 220, WTRU 202 utilizes one or a combination of Bluetooth, WLAN, UWB, IrDA, or other communication technology, to directly broadcast its EDND request 201. The size of the requested EDND zone 203 is determined by the broadcast radius of WTRU 202. As the Figure illustrates, base station 220 is not involved in the broadcast of WTRU's 202 EDND request 201. As a result, base station 220 is not required to process and periodically rebroadcast EDND requests from potentially every WTRU operating within its cell, thereby reducing network traffic. In addition, only those WTRUs within the requested EDND zone 203, in this case WTRU 204, are required to receive and process the local EDND request 201. WTRUs that are not within the local EDND zone 203, such as WTRUs 206 and 208, do not have to process the unaffecting EDND request 201. Further, since the EDND zone 203 is essentially an ad hoc privacy zone, WTRU 202 has the option of selectively utilizing its local EDND zone 203 in an ON/OFF manner.

As described above, if a rogue recording device within WTRU's 202 EDND zone 203 overrides, ignores, or can not process the privacy requests, WTRU 202 may directly broadcast other types of inhibiting signals (e.g. interference signals) to prevent the rogue recording device from engaging in any illicit recording in the local EDND zone 203. Also, in this situation, the WTRU 202 may request assistance from the network 200.

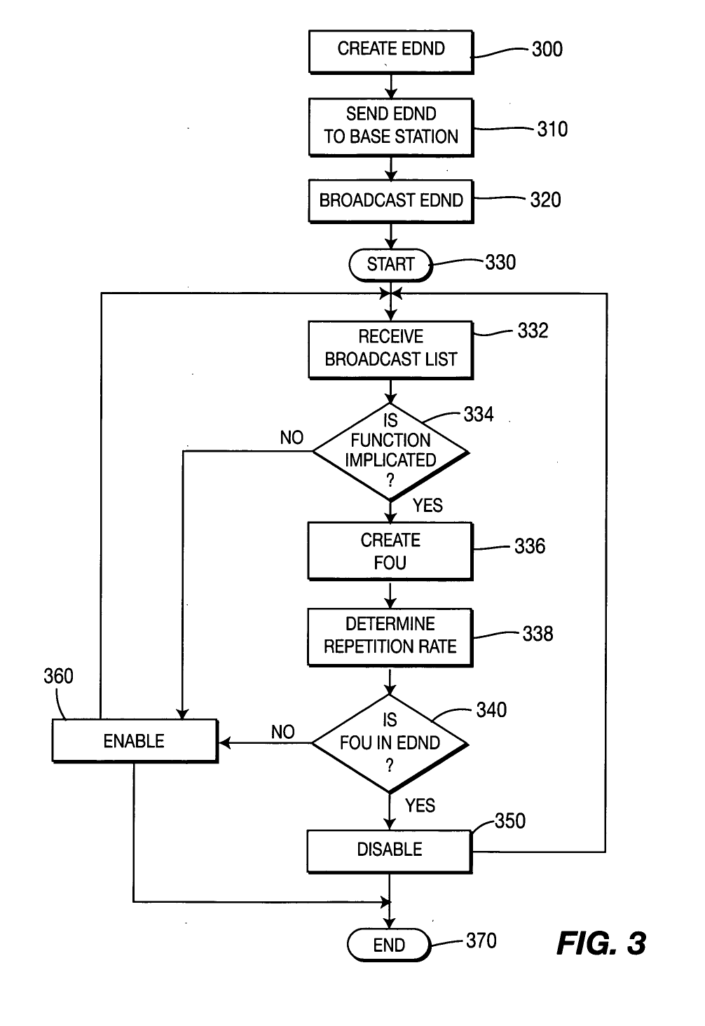

Referring now to FIG. 3, a flow diagram of a method for regulating a recording device embedded in a WTRU using EDND zones is described. In a wireless communication network, a user utilizes a WTRU to create an EDND request message (step 300). This message contains the coordinates of the WTRU, the size of the requested zone, the coordinates of the WTRU, and other relevant information. This EDND request message is sent (step 310) to a base station where it is broadcast (step 320) to all recording devices in its broadcast range, including the requesting WTRU, as an EDND broadcast message. As described above, the EDND broadcast message may include any number of EDND request messages from any number of WTRUs and may be considered a list of EDND request messages (i.e. a broadcast list).

Upon starting or activating a recording function (step 330), a receiving WTRU within the broadcast range of the base station receives and processes the broadcast list (step 332). Alternatively, a receiving WTRU may receive and process all or a sampling of the broadcast list regardless of whether its recording function(s) have been activated. By preemptively processing a broadcast list, the receiving WTRU will ‘know’ ahead of time which functions are desired to be disabled. With this information, the WTRU can avoid enabling recording functions that have been requested to remain disabled. The rate at which the WTRU samples the broadcast list may be based on the WTRU's rate of movement, or on the movements of requesting WTRU(s). If based on the latter, the broadcast list itself may include a suggested sampling rate based on a prediction, made by the base station, of the rate of movement of requesting WTRU(s) in the area.

If the list does not implicate a recording function (step 334), the recording function is enabled (step 360). Otherwise, if the activated recording function is implicated in the broadcast list, the receiving WTRU creates a field of usage (FOU) (step 336) of the recording function.

Once the FOU is created (step 336), the receiving WTRU determines the rate at which it will determine whether the created FOU falls within the requested EDND (step 338). The receiving WTRU then determines whether the FOU of the activated recording function is within the requested EDND zone (step 340). If it is, the recording function remains disabled (step 350). Otherwise, the recording function is enabled (step 360). If disabled (step 350), the receiving WTRU waits until the repetition time determined in step 338 expires and then reexamines the broadcast list (step 332) to determine if the recording function is still implicated (step 334). The recording function remains disabled until it is no longer implicated, until its FOU is no longer in the EDND zone, or until the receiving WTRU deactivates the function (step 370).

If the recording function was enabled (step 360), it will remain enabled until a reexamination of the broadcast list (step 332) indicates that the recording function may fall within a requested EDND zone (step 334), followed by a determination that its FOU is within the requested EDND (steps 336-340). Alternatively, the receiving WTRU can deactivate its recording function at any time, in which case the method ends (step 370). It is noted that, as mentioned in connection with FIG. 2, user defined local EDND zones may also be requested directly from a WTRU instead of through a base station. In this case, step 310 is not needed.

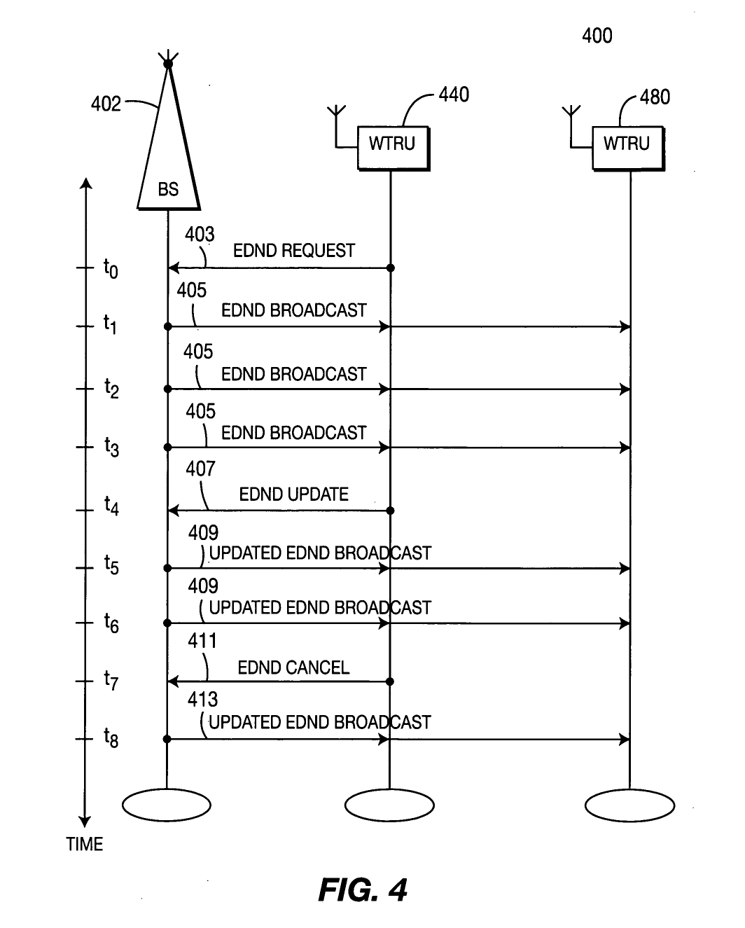

FIG. 4 is a signaling diagram of an exemplary process for creation, updating, and cancellation of EDND zones in accordance with the present invention. At time t0, WTRU 440 generates and transmits an EDND request message 403 to base station 402. This EDND message 403 may include the position coordinates of WTRU 440, the size of the requested EDND zone, and other relevant information. Upon receiving the EDND request, base station 402 adds the request to its broadcast list and broadcasts the list 405 during its broadcast cycle (times t1, t2, and t3) as an EDND broadcast message. It should be noted that the broadcast list is broadcast to both WTRUs 440 and 480. WTRU 440 can receive and review the broadcast list 405 as a means of assuring that its EDND request message 403 was properly received and processed.

At some time later t4, WTRU 440 updates its EDND information. Perhaps WTRU 440 changed its position coordinates, or perhaps it wishes to enlarge or reduce its EDND zone. To effectuate this change, WTRU 440 sends an EDND update message 407 to base station 402. Upon receiving this update 407, base station 402 updates its broadcast list accordingly and transmits its updated broadcast list 409 in accordance with its broadcast cycle at times t5 and t6.

At time t7, WTRU 440 determines it no longer requires an EDND zone. Accordingly, WTRU prepares and transmits an EDND cancel message 411 to base station 402. Upon receiving the cancel message 411, base station 402 removes the updated EDND request 407 from its broadcast list and transmits a newly updated broadcast list 413 without WTRU 440's EDND zone information. WTRU 440 receives and reviews the broadcast list at time t8 to ensure that its EDND Cancel message 411 was properly processed.

It should be noted that in addition to sending change effectuating update messages, WTRU 440 may be configured to periodically send status update messages, regardless of whether anything has changed. These periodic updates, for example, would allow base station 402 to ‘know’ that WTRU's 440 still desired an EDND zone. If base station 402 would cease receiving these periodic updates, it could release the WTRU's 440 EDND zone without receiving an EDND cancel message from WTRU 440.

In an alternate embodiment, rather than requiring receiving WTRUs to continually determine their relative distance to requested EDND zones, a servicing base station may make such determinations. Certain radio technologies such as code division multiple access (CDMA) and wideband CDMA (WCDMA), for example, when coupled with smart antennas or phased antenna arrays, permit a base station to track individual WTRUs. In such a deployment, receiving WTRUs are only required to send an initial activation inquiry to a base station. In response, the base station begins to track these receiving WTRUs and their proximity to any previously broadcast EDND zones. By continuing to track the positions of receiving WTRUs, the base station is able to send directed disabling (or enabling) commands to only those receiving WTRUs that are violating EDND requests. Since receiving WTRUs are not required to make any such determinations, the present deployment is a power saving alternative for any such receiving WTRUs.

In an alternate embodiment, the local EDND zones described above may be created using alternative technologies available in embedded recording devices. This alternative is particularly preferred when position location signals cannot be received or are inaccurate. Examples of such technologies include Infrared Data Association (IrDA), Bluetooth, wireless local area network (WLAN), ultra wideband (UWB), and the like. As described in the previous embodiment, a requesting WTRU determines which sensing components it wishes to disable (or enable). Rather than defining and sending zone information to a base station for transmission, the requesting WTRU utilizes one (or more) of the technologies mentioned above to mark its local EDND zone. The transmission range of the device's radio signals determines the size of the requested zone. As a result, any WTRU entering the broadcast radius of the requesting WTRU will continue to receive these radio signals until they move beyond the broadcast radius. In such a deployment, the requesting user may have to use these EDND zones in an ON/OFF manner.

It should be noted that the local EDND zones of the present embodiment may or may not be within the jurisdiction of a cellular provider. If these zones are not so governed by a cellular provider, it is possible that a receiving WTRU may choose to ignore these EDND requests. If these zones are created in conjunction with a cellular service provider, appropriate override keys can be exchanged to enforce new policies dictated by EDND zones.

In any of the previously described embodiments, it may be necessary for particular users, such as law enforcement officials, for instance, to have an option of ignoring requested EDND zones, local or otherwise. Accordingly, the present embodiment utilizes override mechanisms to allow such users to ignore EDND zones. Each override mechanism corresponds to a particular recording device and to a particular authorized user. Unique device and user identifiers are utilized to control the use of such mechanisms and to authenticate override requests. Unique device identifiers such as, for example, electronic serial numbers (ESN), may be utilized to control the use of the override mechanism. Similarly, a unique user identifier such as, for example, fingerprints, retinal signatures, voice patterns, or the like, may be utilized to authenticate an user attempting to activate the override mechanism.

For those users who are not given the option of ignoring EDND zone requests, a permission system may be employed whereby a user whose sensing functions have been disabled may generate and send a reply to the received EDND request. This reply is sent to a servicing base station in the form of an override-request message. The base station, upon receiving this override-request, forwards the request to the EDND originator along with identification information of the override requester. The EDND originator, in turn, may grant or deny usage permission based on any criteria. In cases involving covert law enforcement investigations, the override-request message, after being identified as coming from authorized law enforcement, may be forwarded to an administrative, possibly judicial, function of government, rather than to the EDND originator. This allows for independent time-based control of the override function, as well as the ability to maintain an independent audit log of its use.

In the above described embodiments, it should be noted that local ranging may be utilized in conjunction with embedded position location components to narrow the margin of error of positioning using alternative radio technologies. In addition, local ranging may be utilized to provide a display of all requested EDND zones in the vicinity of a recording device.

Although the elements in the Figures are illustrated as separate elements, these elements may be implemented on a single integrated circuit (IC), such as an application specific integrated circuit (ASIC), multiple ICs, discrete components, or a combination of discrete components and IC(s). Although the features and elements of the present invention are described in the preferred embodiments in particular combinations, each feature or element can be used alone without the other features and elements of the preferred embodiments or in various combinations with or without other features and elements of the present invention. Furthermore, the present invention may be implemented in any type of wireless communication system.

1. In a wireless communication system, a method for selectively regulating a plurality of recording devices, the method comprising:
(a) defining a regulation zone;
(b) generating inhibiting signals encoded with sensing inhibiting information; and
(c) broadcasting the sensing inhibiting signals to regulate recording devices within the regulation zone.

2. The method of claim of claim 1 wherein the inhibiting signals are encoded to enable at least one sensing function of at least one recording device wherein the one sensing function is disabled by the inhibiting signals in other recording devices.

3. The method of claim 1 wherein the inhibiting signals are encoded to disable at least one sensing function of at least one recording device.

4. The method of claim 3 wherein the inhibiting signals affect only those recording devices without or not utilizing a means for overriding said signals.

5. The method of claim 3 wherein the inhibiting signals are further encoded to disable the at least one sensing function of at least one recording device for a limited period of time.

6. The method of claim 1 wherein the inhibiting signals are encoded to partially disable at least one sensing function of at least one recording device.

7. The method of claim 1 wherein the inhibiting signals are encoded with a combination of enabling and disabling information.

8. The method of claim 1 wherein the inhibiting signals only affect those recording devices with particular identifiers.

9. The method of claim 1 wherein the inhibiting signals are detected by sensing components configured to detect inhibiting signals and to provide sensing functions to the recording devices.

10. The method of claim 9 wherein the sensing components are image sensing components.

11. The method of claim 9 wherein the sensing components are audio sensing components.

12. The method of claim 9 wherein the sensing components are configured to sense electromagnetic intensity.

13. The method of claim 9 wherein the sensing components are configured to sense acoustical intensity

14. The method of claim 1 wherein the inhibiting signals are interference signals.

15. The method of claim 14 wherein the interference signals cause sensing components embedded in the recording devices to function improperly.

16. The method of claim 14 wherein the interference signals are generated in frequency bands to which sensing components are highly sensitive and to which humans have a low sensitivity.

17. The method of claim 16 wherein the interference signals are electromagnetic signals.

18. The method of claim 16 wherein the interference signals are audio signals.

19. The method of claim 1 further comprising:
(d) broadcasting signal-override information to authorized recording devices, said information being used to override the inhibiting signals of step (c).

20. The method of claim 1 further comprising:
(a1) determining the coordinates of the regulation zone;
(a2) registering the coordinates of the regulation zone with a base station; and
(c1) in the base station, broadcasting sensing inhibiting signals for regulating recording devices located in the regulation zone.

21. The method of claim 20 wherein the inhibiting signals are electronic do-not-disturb requests.

22. The method of claim 20 wherein the inhibiting signals are interference signals.

23. The method of claim 20 wherein step (c1) further comprises:
(c11) maintaining a list of authorized recording devices, wherein the inhibiting signals deactivate unauthorized recording devices located in the regulation zone.

24. The method of claim 23 wherein the deactivated recording devices are activated once they are outside of the regulation zone.

25. The method of claim 20 wherein the regulation zone is mobile, said method further comprising periodically determining and registering the coordinates of the regulation zone.

26. The method of claim 20 further comprising:
(d) in the recording devices:
(d1) receiving the inhibiting signals;
(d2) determining the coordinates of a field of usage of said recording devices;
(d3) determining whether the field of usage is in the regulation zone; and
(d4) disabling sensing components as requested by the inhibiting signals when the field of usage is in the regulation zone.

27. The method of claim 26 wherein the recording devices are configured to inhibit their field of usage to prevent said field of usage from entering the regulation zone.

28. The method of claim 26 further comprising:
(d11) storing the inhibiting signals; and
(d12) periodically updating the stored signals.

29. The method of claim 26 wherein the base station monitors the location of the recording devices and determines if the field of usage of said recording devices is in the regulation zone.

30. The method of claim 29 wherein the base station utilizes code division multiple access (CDMA) or wideband (CDMA) coupled with smart antennas to monitor the recording devices.

31. The method of claim 29 wherein the base station utilizes Orthogonal Frequency Division Multiplex (OFDM) coupled with smart antennas to monitor the recording devices.

32. The method of claim 29 wherein the base station utilizes Wireless Local Area Network standards coupled with smart antennas to monitor the recording devices.

33. The method of claim 29 wherein the base station utilizes global positioning technology to monitor the recording devices.

34. In a wireless communication system, a wireless transmit/receive unit (WTRU) configured to selectively regulate recording devices, the WTRU comprising:
(a) means capable of defining a regulation zone;
(b) means capable of generating signals encoded with sensing inhibiting information; and
(c) means capable of broadcasting the sensing inhibiting signals to regulate recording devices located within the regulation zone.
